(19) United States
(12) Patent Application Publication
(10) Pub. No.: US 2007/0198157 A1
(43) Pub. Date: Aug. 23, 2007

(54) Safety Device For A Fork Lift Truck

(75) Inventor: Vanni Righi, Correggio (Reggio Emilia) (IT)

Correspondence Address: PEARNE & GORDON LLP, 1801 EAST 9TH STREET, SUITE 1200, CLEVELAND, OH, 44114-3108, US

(73) Assignee: Cesab Carrelli Elevatori S.p.A., Bologna (IT)

(21) Appl. No.: 10/569,477

(22) PCT Filed: Feb. 28, 2005
(86) PCT No.: PCT/IB05/00554

§ 371 Date: Feb. 22, 2006

(30) Foreign Application Priority Data
Jun. 22, 2004 (IT) B02004A000393
Dec. 20, 2004 (IT) BO2004A000787

(51) Int. Cl. G06F 19/00

(52) U.S. Cl. 701/50; 701/45

(57) ABSTRACT

A safety device (1) for a fork lift truck (2) comprising a chassis (3), a front axle (4) and a rear axle (5) fitted with respective wheels (6, 7) and supporting the chassis (3), a lifting apparatus (8) attached to the chassis (3) at the front axle (4). The device (1) comprises means (31) for acquiring information relative to the load (X) lifted by the apparatus (8), a processing unit (18) connected to the acquisition means (31), and safety means (30) which act on the truck (2) following a signal (S, S1, S2) processed by the processing unit (18). The acquisition means (31) comprise a detector (50) attached to the lifting apparatus (8).

### TECHNICAL FIELD

The present invention relates to a safety device for fork lift trucks and the like, for example counterbalanced fork lift trucks, retractable trucks, stackers, pilers, trucks with lift platform, etc.

In the following description specific reference is made to a safety device for counterbalanced fork lift trucks, without in any way limiting the scope of the inventive concept.

### BACKGROUND ART

A standard configuration of the latter has a chassis with two axles, one at the front and a steering axle at the rear.

The front axle normally has two wheels close to a lifting apparatus located at the front end of the chassis.

At the back, the truck may have a set of counterweights attached to the chassis and the rear steering axle which may have two transversally distanced wheels, similarly to the front axle. Alternatively, the rear axle may have two wheels set close together, also known as twin wheels, which turn about a shared vertical axis, or the rear axle may comprise a single rear wheel located at the longitudinal centre line of the truck and also turning relative to a vertical axis.

The lifting apparatus normally comprises a fork mobile up and down, using a vertical mast, driven by one or more hydraulic lifting pistons.

Fork lift trucks are often used for handling considerable weights which reduce truck stability due to the particular distribution of the weights created according to the contact surface defined by the wheels.

This reduced stability, also depending on the dynamic phenomena caused with the longitudinal end transversal accelerations to which the truck is subjected during use, may cause the truck or the weight supported by the fork to tip over.

Many devices have been studied with the aim of increasing the safety of fork lift trucks, in particular devices designed to reduce the risk of trucks tipping over.

Most of the known above-mentioned devices are designed to evaluate, moment by moment, the load situation with measurements on the front lifting apparatus.

However, these solutions do not give a real image of the stability of the entire truck, load and contact surface.

Safety devices have also been studied, such as that described in patent EP-0 465 838, in which the truck is equipped with a unit for fixing the rear axle which slides along a substantially vertical guide, Bo as to apply load factors to the distribution of the weights on the axles.

The fixing unit comprises a potentiometer attached to the lifting piston to detect the relative movement between the chassis and the rear axle fixing unit.

If the rear axle and the chassis move away from one another too far, triggering a potential forward tipping motion, the potentiometer interacts, by means of suitable interfaces, with the hydraulic lifting piston, to re-establish an equilibrium, substantially, on the position of the load.

Said device has some disadvantages due to the complex structure of the rear axle fixing unit, which requires a particular construction architecture involving considerable costs for the fork lift truck and frequent and constant adjustments.

### DISCLOSURE OF THE INVENTION

One aim of the present invention is to provide an improved safety device for fork lift trucks, which takes into account the distribution of the weights on the contact surface and is simple to implement and easy to attach substantially to any type of fork lift truck without extensive work on the truck structure.

In accordance with one aspect of it, the present invention proposes a safety device as specified in claim 1.

The dependent claims refer to preferred, advantageous embodiments of the invention.

### BRIEF DESCRIPTION OF THE DRAWINGS

Embodiments of the present invention are described below, without in any way limiting the scope of the inventive concept and with reference to the accompanying drawings, in which:

FIG. 1 is a schematic side view of a fork lift truck equipped with a safety device according to the present invention;

FIG. 1a is a view of a further detail of the fork lift truck safety device illustrated in FIG. 1;

FIG. 2a is an enlarged schematic rear view of a detail of the device illustrated in FIG. 1a;

FIG. 2b is an enlarged schematic rear view of a different embodiment of the same detail as illustrated in 2a;

FIG. 2c is a top plan view of the detail illustrated in FIG. 2b;

FIG. 3 is a schematic block diagram relative to an operating strategy for the safety device according to the present invention;

FIGS. 4a to 4e are flow charts illustrating the blocks in the diagram illustrated in FIG. 3.

### DETAILED DESCRIPTION OF THE PREFERRED EMBODIMENTS OF THE INVENTION

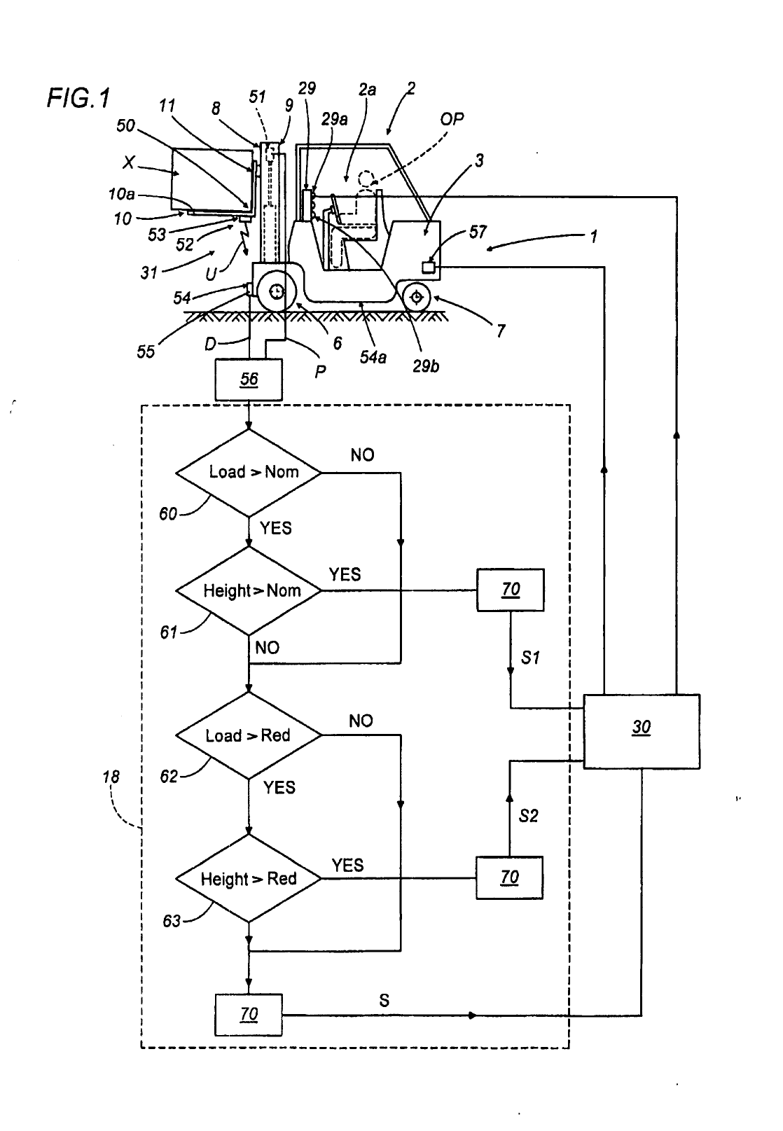

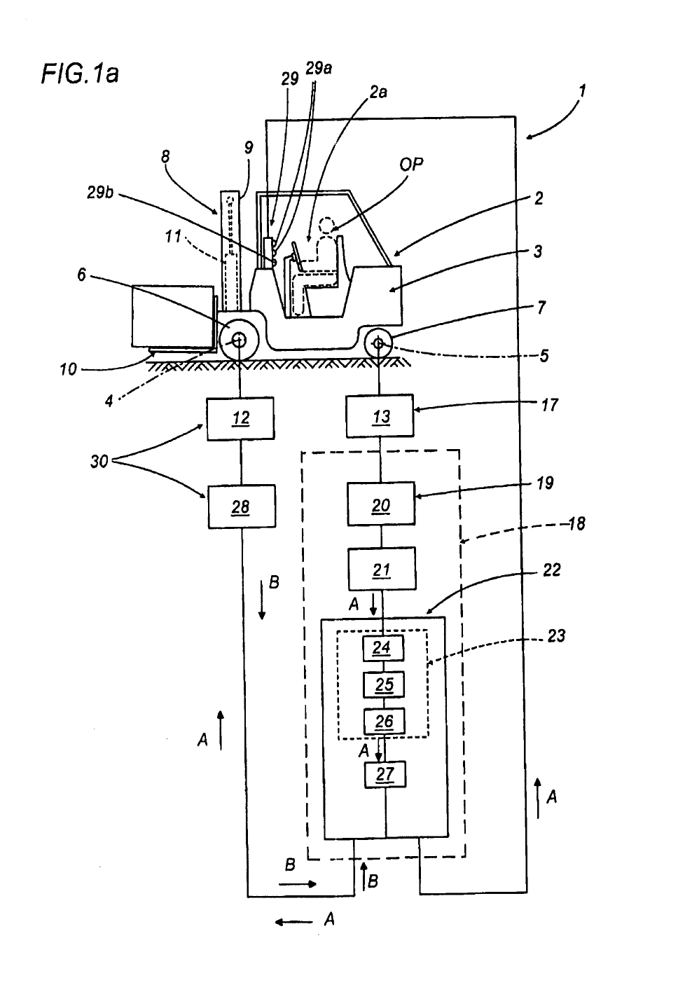

In particular with reference to FIG. 1, the numeral 1 denotes as a whole a safety or anti-tipping device for a fork lift truck 2.

The fork lift truck 2, of the substantially known type, therefore, with only the parts necessary for an understanding of the text described, comprises a chassis 3 supported by a front axle 4 and a rear axle 5 fitted with respective wheels 6 and 7 and a truck 2 driving position 2a.

The following description considers the general case of a four-wheeled truck 2 in which the front wheels 6 are non-steering and the rear wheel 7 are directional.

The truck 2 is equipped with a lifting apparatus 8 located at the front wheels 6 and substantially comprising a mast 9 which tilts relative to the chassis 3 (swinging movement). A slide 10 driven by a piston 11, which may for example be hydraulic, slides along the mast 9 from the bottom to the top and vice versa.

The slide 10 advantageously consists of a fork 10a set up to support and handle a load X illustrated in FIGS. 1 and 1a.

According to substantially known construction architectures, the truck 2 comprises a communication channel 12 (for example of the CAN-bus type) supporting most of the instructions and information relative to truck 2 operation, that is to say, the main operating parameters and commands set by a driver OP for the truck 2.

The device 1, as described below, interacts with truck 2 dynamics through the communication channel 12.

In particular with reference to FIG. 1, it may be seen how the device 1 comprises means 31 for acquiring information about the load X lifted by the slide 10.

The acquisition means 31 comprise a detector 50 attached to the lifting apparatus 8.

In detail, the detector 50 has a weight sensor 51 for measuring a weight value P for the load X lifted by the slide 10.

The weight sensor 51 advantageously consists of a load cell of the known type and therefore not described in further detail.

In accordance with the preferred embodiment illustrated in FIG. 1, the weight sensor 51 is attached to the piston 11 which is located at the mast 9. Alternatively, the weight sensor 51 may be attached directly to the slide 10.

The detector 50 also has a height sensor 52 for measuring a distance D from the base of the chassis 3 to the load X.

In further detail, the height sensor 52 consists of a transmitter element 53 which sends an ultrasound signal U and a receiver element 54 which picks up the signal U.

The transmitter element 53 is preferably attached to the fork 10a, whilst the receiver element 54 is located in a base portion 54a of the chassis 3 corresponding to the base on which the entire truck 2 rests.

The height sensor 52 also has a block 55 for processing the ultrasound signal U, the block 55 supplying a value representing the distance D according to the speed at which the signal U is issued (speed of sound) and the time taken for the signal U to be picked up.

In other words, the transmitter element 53 sends the signal U at a predetermined frequency, for example 40 kHz, for 1 ms every 100 ms. At the same time, the block 55 activates a counter which is stopped at the moment when the receiver element 54 picks up the signal U. The block 55 now contains a value which is the signal transfer time, which calculated according to the constant speed provides the distance value D representing the distance between the slide 10 and the base 54a of the chassis 3.

The device also has an analogue—digital converter 56 for converting the weight value P and height value D supplied by the sensors 51, 52 from analogue to digital values.

The acquisition means 31 described above are advantageously connected to a processing unit 18.

The processing unit 18 is advantageously connected to the converter 56 so that it receives the digital values, compares them with preset weight and height parameters and sends a signal S representing the truck 2 safety status.

In other words, with reference to the flow chart in FIG. 1, the processing unit 18 detects whether or not the weight value P and distance are greater than the preset load and height safety values.

In particular, in the block 60 the weight value P is compared with a nominal load value. If said value P is greater than the nominal load, block 61 performs a comparison to check if the distance value D is greater than a nominal height value. If the distance value D is also greater than the height value, a signal S1 is sent to a block 70 representing a risk status for the load X lifted.

If the weight value P is less than the nominal load value, or if the weight value is greater than the nominal load value but the distance value D is less than the nominal height value, a further comparison is performed between reduced load and reduced height values and the weight value P and distance value D.

In practice, the reduced load value consists of a weight value which depends on the height (the load is reduced as the height increases), and similarly the reduced height value represents a distance value which depends on the load.

Therefore, block 62 compares the weight value P with the reduced load value. If the weight P is less than the load, the signal S representing the safe status for the load X lifted is sent. In contrast, if the weight value P is greater, block 63 performs a comparison to check if the distance value D is greater than the reduced height value. If the distance value D is less, then the signal S representing the safe status is sent, otherwise, if the value D is greater, a signal S2 representing a risk status for the load X lifted is sent.

The signals S, S1 and S2 are sent to a block 70 directly connected to safety means 30 operatively connected to the truck 2 so that they can act on it.

In particular, the safety means 30 have an indicator device 29 attached to the truck 2. When the safety means 30 receive the signal S representing the safe status for the load X lifted, the indicator device is not activated and the truck is allowed to operate freely.

If the safety means 30 receive signals S1 and S2 representing a risk status for the load X lifted, the indicator device is activated.

The indicator device 29 may consist of a visual warning device 29a and/or an acoustic alarm 29b, as described in more detail below.

Moreover, the safety means have a control part 57 for activating or deactivating the lifting apparatus 8 depending on the signal processed by the processing unit 18.

In other words, if the signals S1 and S2 dangerously exceed a predetermined safety threshold, the control part 57 deactivates the lifting apparatus 8 to prevent the risk of the truck tipping over. Alternatively or additionally, the acquisition means 31 may also have a load detector 13 integral with the rear axle 5 of the truck 2 (FIG. 1a).

In more detail, in the embodiment illustrated in FIG. 1a, the detector 13 comprises a bar 14, for example ferrous or made of a material with similar elastic properties, secured on the rear axle 5 so that it substantially becomes completely integral with it and precisely reproduces its deformations, as explained below.

At the ends of the bar 14 there are a pair of holes 14a with which it is fixed to the rear axle 5 using two bolts 14b.

The detector 13 also comprises a pair of Wheatstone strain gauge bridges 15, of the substantially known type, which are glued to the bar 14.

Advantageously, the device 1 has two bridges 15 to allow for any deterioration in their characteristics and to allow for any malfunctions in one of the two. The bridges 15 are installed in a redundant manner to guarantee service continuity.

It should be noticed that, as is known, each Wheatstone strain gauge bridge 15 comprises four strain gauges which may be of any substantially known type, for example, with semiconductor (or piezoresistive), glued conductor (or metal layer or plate), non-glued conductor (or wire strain gauge).

Operation of the bridge 15, substantially known, is based on the variation in resistance due to a change in the cross-section/length ratio of a conductor subjected to a stress and so deformed.

In alternative embodiments, the Wheatstone bridge or bridges 15 are substituted with one or more simple strain gauges 16 with the same functions as the bridge 15.

It should be noticed that the axle 5 normally comprises a substantially middle portion 5a and two half-parts 5b with pins 5c to which the wheels 7 are attached.

The truck 2 rests on the ground with its wheels 7 and is attached to the chassis 3 at the portion 5a.

In this way, the axle 5 is subject to a bending deformation due to the weight above it, at the portion 5a, and the reaction of the ground through the wheels 7. For this reason the axle 5 has a deformation characterised by lengthening of the lower fibres, facing the ground, and shortening of the upper fibres, facing the chassis 3.

Similarly, the bar 14, integral with the axle 5, has stretched lower fibres and shortened upper fibres and the bridges 15 detect said deformation.

In the preferred embodiment illustrated, the load detector 13 is located below the axle 5, to measure the lengthening of the stretched fibres.

More specifically, the bar 14 is rendered integral with the lower part of the axle 5 and the bridges 15 are in turn glued underneath the bar 14.

In alternative embodiments not illustrated, the device 1 has only one bridge 15, or only one simple strain gauge 16, just as efficient in managing truck 2 stability, as described below, more economical but less reliable than the embodiment with two bridges in terms of service continuity.

The bar 14 may also be attached to the top of the axle 5 and the bridges 15 (or simple strain gauges 16) glued in place so that they detect the shortening of the upper fibres.

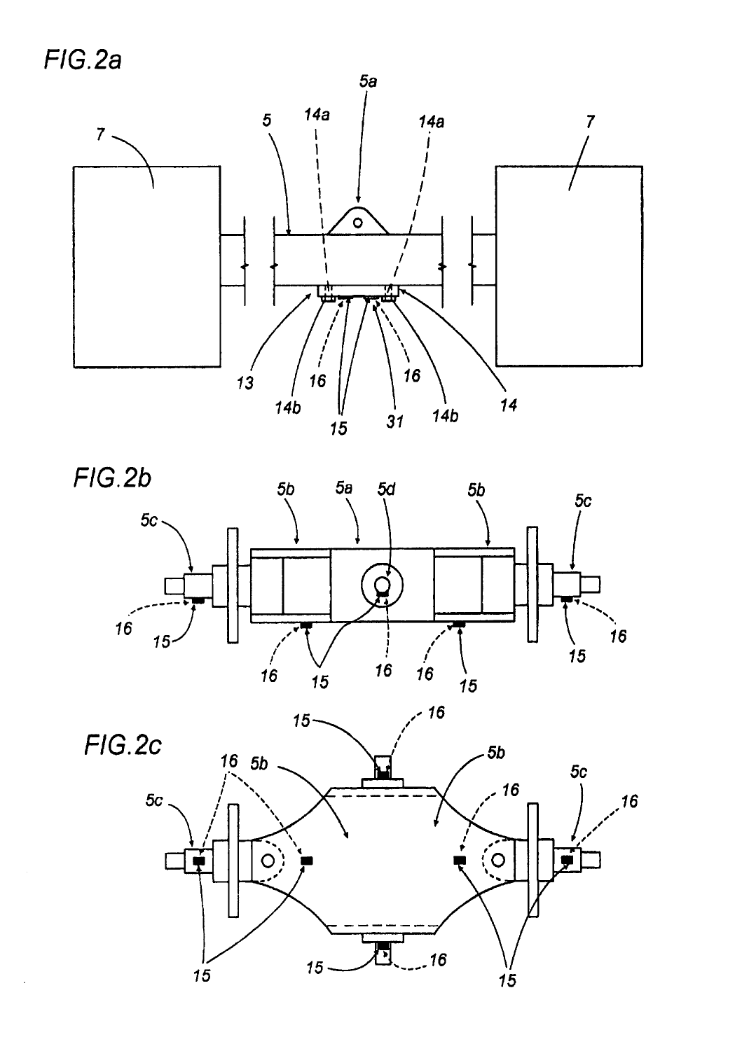

In particular with reference to FIGS. 2b and 2c, it should be noticed that the strain gauge bridges 15 or simple strain gauges 16 are located in different positions to those in FIG. 2a and may be directly glued to the rear axle 5 so that they detect the deformations directly without insertion of the bar 14 in between.

In particular, they may be attached to the axle 5 at an axle oscillating pivot 5d, or they may be attached at wheel 7 supporting pins 5c.

Moreover, advantageously, a strain gauge bridge 15 may be attached to each half-part 5b of the axle 5.

In the case of the device 1, in the preferred embodiment illustrated, the bar 14 and the bridge 15 are clamped to the axle 5 with the truck 2 completely unloaded and without the driver OP, to supply a substantially null value analogue signal in this condition, that is to say, with the axle 5 only subject to the weight of the truck 2.

The analogue signal from the bridge 15 varies with increases or reductions in the overall load on the rear axle 5. In particular, the percentage value increases when the axle 5 itself becomes lighter.

In this way, the analogue signal contains information about the distribution of the weights relative to the rear axle 5, that is to say, as described in more detail below, relative to the truck 2 equilibrium.

The bridges 15, or simple strain gauges 16, in general form a strain gauge transducer 17.

The latter is connected at the input of the processing unit 18 which receives the analogue signal detected by the bridges 15 or the simple strain gauges 16.

Obviously, the processing unit 18 is made differently and appropriately if it must process signals from bridges 15 or from simple strain gauges 16.

In this embodiment a first stage of the unit 18 comprises an analogue conditioning device 19.

The device 19 is designed to acquire and condition the signal from the transducer 17 to remove from it any interference and errors normally due to dispersion of the electrical characteristics in the load detector 13.

By way of example, the device 19 may comprise a differential amplifier 20 for instruments, of the substantially known type and therefore not described in detail.

Downstream of the device 19, according to a direction of data feed A, the processing unit 18 comprises an analogue—digital converter 21 for converting the analogue signal into a digital signal. For example, the converter 21 is of the 10 bit type with a 1 kHz conversion speed.

Advantageously, in alternative embodiments not illustrated, the converter 21 may be of any type and have different characteristic parameters, depending on the required speed and resolution.

In this embodiment, the processing unit 18 comprises, downstream of the converter 21 according to the direction A, a computerised check and control unit 22, which, at its input, has a digital conditioning device 23 designed to modulate the digital signal generated by the converter 21.

In more detail, in the preferred embodiment illustrated, the device 23 comprises, one after another according to the direction A, a digital amplifier 24 with filter, a digital filter 25 and a digital amplifier 26 with hysteresis.

The amplifiers 24 and 26 and the filter 25 are of the substantially known type, therefore they are not described in detail, and transmit the suitably cleaned up and modulated digital signal downstream according to the direction A.

The digital signal modulated in this way indicates the distribution of the weights relative to the rear axle 5 and will be referred to, in the description below, as the load indication or signal C, relative to the rear axle 5.

A processor 27 is connected to the digital conditioning device 23, receives the signal C as input, and implements a device 1 use and operation strategy, an example of which is described below.

Downstream of the check and control unit 22, in particular of the processor 27, according to the direction A, the device 1 comprises an interface 28 located and active between the unit 22 and the communication channel 12.

In particular, the interface 28 allows the check and control unit 22 to acquire most of the above-mentioned instructions and information about truck 2 operation, which substantially pass from the truck to the check and control unit 22 according to a direction B.

The same instructions and information are returned, according to the direction A, to the truck 2, suitably reprocessed, substantially according to the above-mentioned load indication C.

The indicator device 29 is located on the truck 2 close to the driving position 2a and is controlled by the check and control unit 22 processor 27.

The device 29 described above has a visual warning device 29a, for example a set of LEDs in different colours, and an acoustic alarm 29b of the known type and therefore not described in detail.

It may be assumed, for example and for the sake of simplicity, that there are four yellow LEDs, two green LEDs and one red LED forming a LED scale and constituting the visual warning device 29a, and a buzzer constituting the acoustic alarm 29b. Advantageously, there may be any number of LEDs in any colours, according to the type of visual indication to be supplied; the visual warning device 29a may also comprise an indicator with a pointer movable on a graduated scale.

The device 29, including the LEDs and the buzzer, together with the communication channel 12 and the interface 28, forms safety means 30. Similarly, the load detector 13 together with the bar 14, the Wheatstone bridge or bridges 15 and the strain gauges, forms the means 31 for acquiring information about the truck 2 equilibrium.

In practice, when the truck 2 lifts a heavy load or a load X to a height greater than that allowed, the detector 50 sends the weight signal P and the distance signal D to the unit 18 which processes the signals. After the processing described above, performed by the unit 18, a signal S, S1 or S2 is sent to the safety means 30. At this point, if the signal represents a truck 2 risk status, the means 30 stop the lifting apparatus 8 or warn the operator OP acoustically/visually.

In addition, or alternatively, considering the truck 2 longitudinal equilibrium in any operating condition, it should be noticed that, in the case of front tipping forward, of particular interest in this text, the overall weight of the truck 2 is transferred towards the front axle 4, which tends to become the only point at which the truck 2 makes contact with the ground.

In other words, as a front tipping condition approaches, the weight sustained by the rear axle 5 tends to be reduced to zero and the axle 5 tends to be completely unloaded.

The strain gauge transducer 17, substantially measuring the bending of the axle 5 with the change in truck 2 use and load conditions, produces the signal C, which is an indicator of the truck 2 equilibrium.

As already indicated, in the preferred embodiment illustrated, the signal C is acquired and modulated in such a way that the signal C increases as a positive percentage gradually as the rear axle 5 is unloaded.

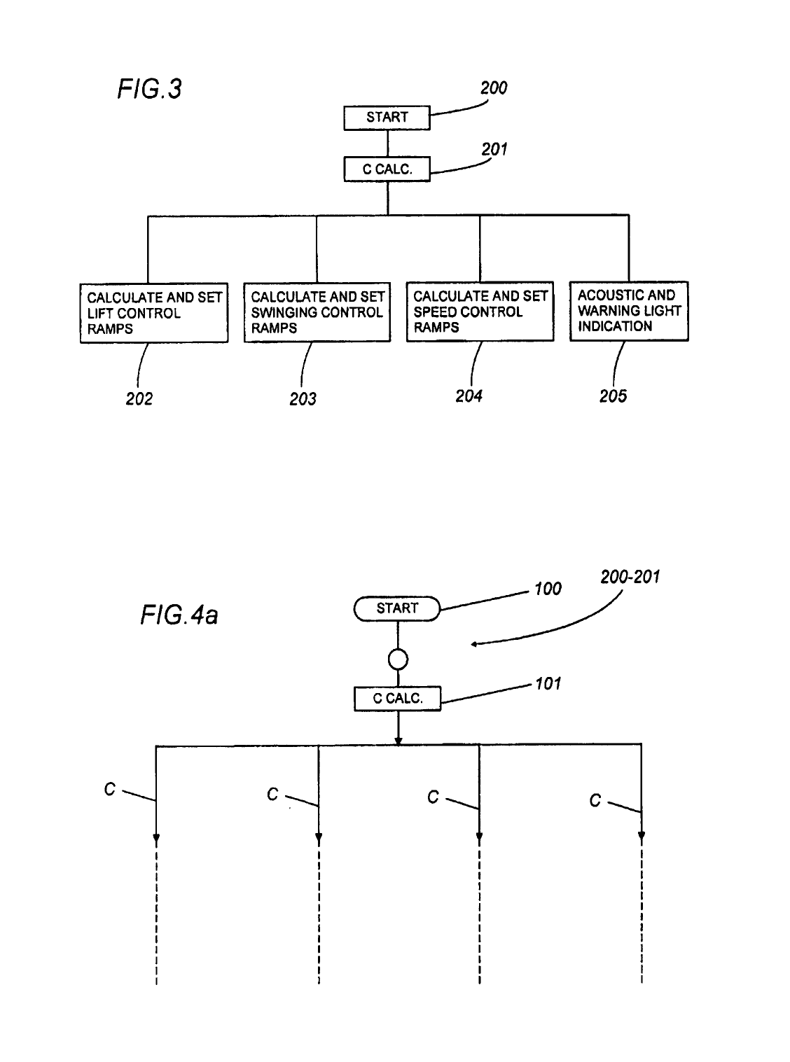

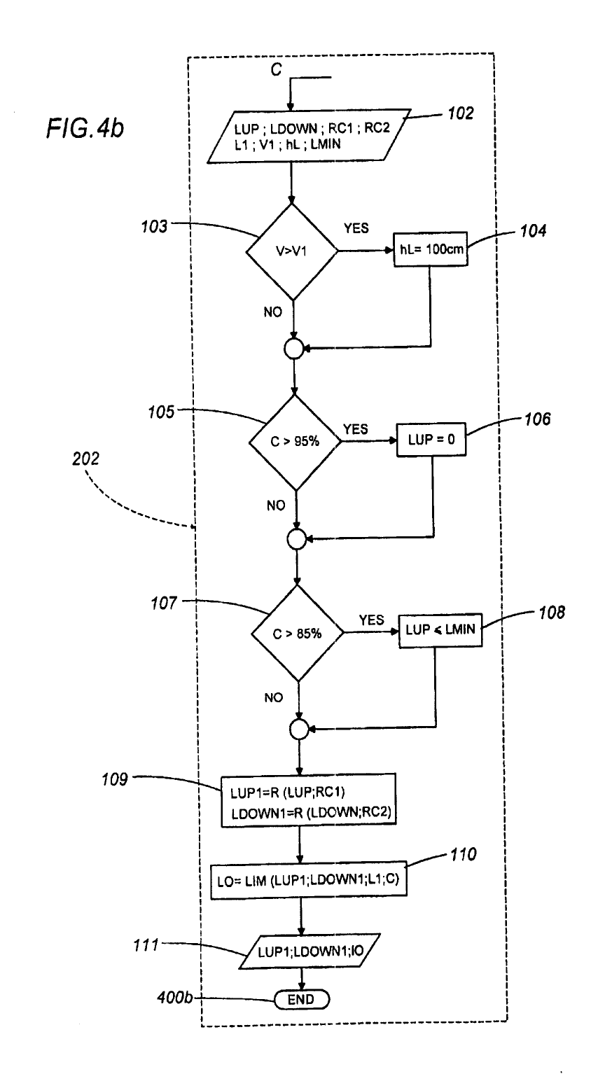

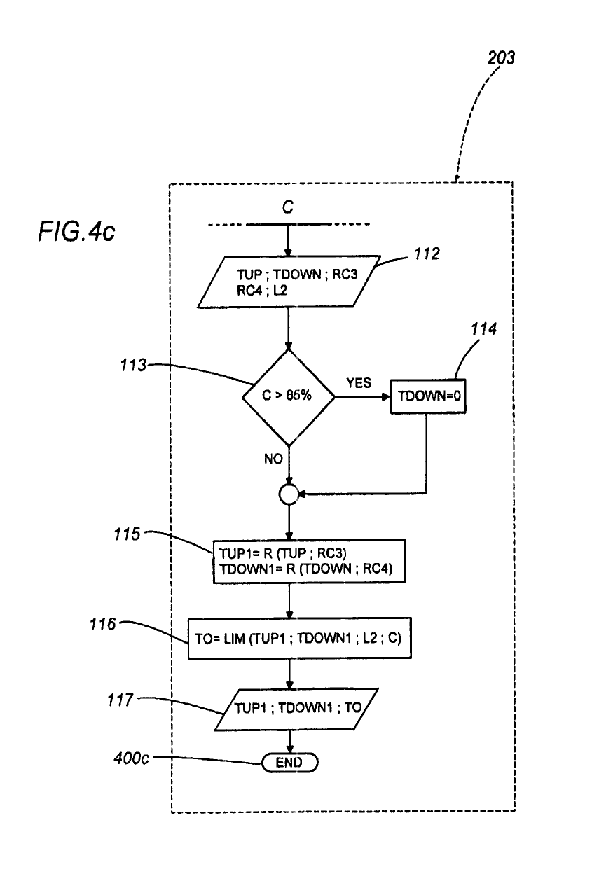

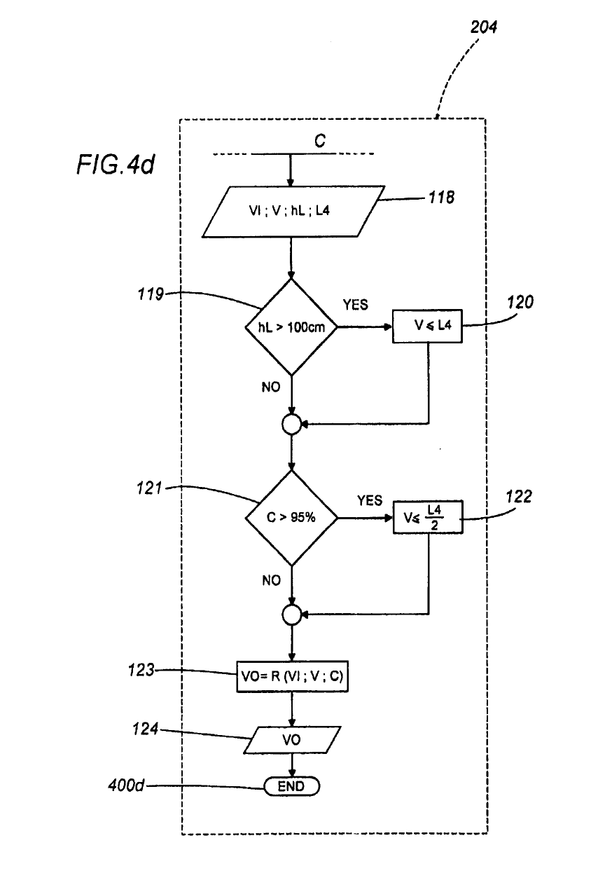

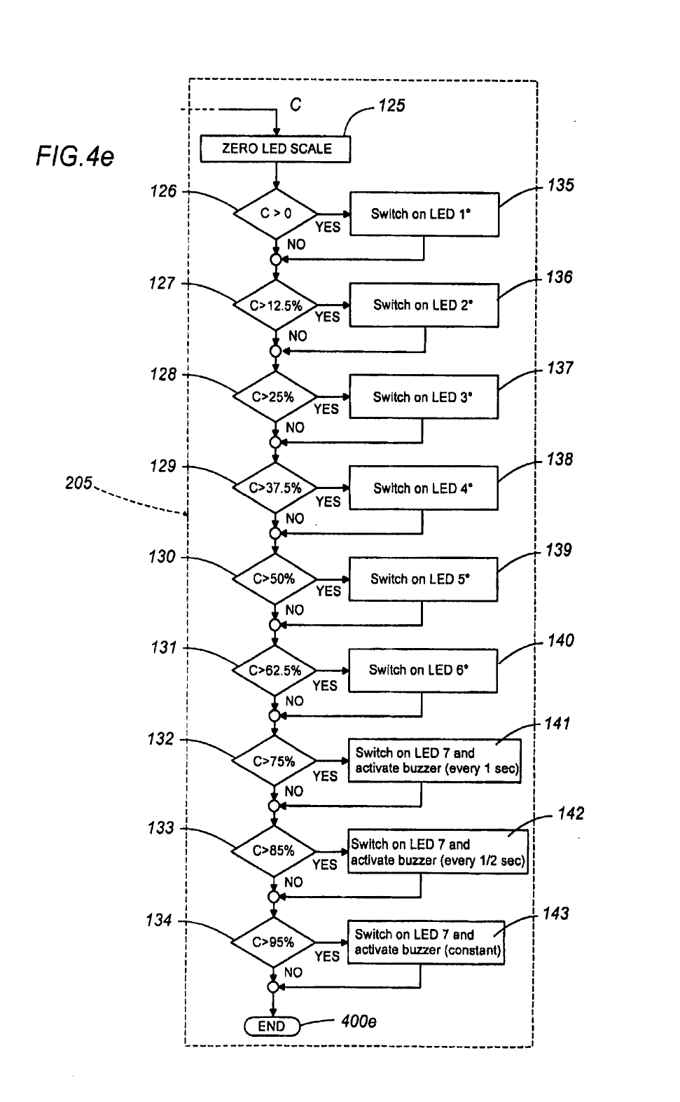

The block diagram in FIG. 3 is described in detail in the flow charts illustrated in FIGS. 4a to 4e.

It should be noticed that the data about the truck 2 is acquired in operating blocks 102, 112 and 118 and, as indicated, during actual operation the data comes from the communication channel 12 according to the direction verso B, whilst comparison constants and parameters come from memory cells, not illustrated, which can be used by the processing unit 18.

In a substantially similar way, the instructions or commands implemented in the operating blocks 202, 203 and 204 are made available, during actual operation, on the communication channel 12 by the respective operating blocks 111, 117 and 124.

With reference to FIG. 4a, it should be noticed that the schematic blocks 200 and 201 can be represented, in the flow chart, simply as a start operating block 100 and a calculating operating block 101 where the signal C is quantified and sent to the next blocks.

With reference to FIG. 4b, the flow chart illustrated schematises the procedure for calculating LUP1 and LDOWN1 command ramps for the slide 10 upstroke and downstroke according to the LUP and LDOWN commands set by the driver OP and a limit LO on the slide 10 upstroke and downstroke speed.

In operating block 103 the truck 2 speed of movement V is compared with a reference value V1, for example 6 km/h. If the speed V is greater than V1 the slide 10 is stopped at a height ‘hL’ equal to a limit value, for example 100 cm (operating block 104).

Then, in operating block 105, the signal C is assessed and if it is greater than 95%, the slide 10 upstroke is stopped and inhibited, setting a null LUP command (operating block 106); advantageously, it is still possible to lower the slide 10.

If the signal C is greater than 85% but less than 95% (operating block 107), the slide 10 upstroke command LUP is limited to a minimum value LMIN, at operating block 108.

In operating block 109 the LUP1 and LDOWN1 ramps are calculated as a function R of the LUP, LDOWN commands and of time constants RC1 and RC2.

Said ramps are calculated to soften the LUP and LDOWN commands, normally of the step type, set by the driver OP for the truck 2, according to the constants RC1 and RC2.

In operating block 110 another limit LO is implemented on the slide 10 movement speed, both up and down, according to the LUP1 and LDOWN1 commands, calculated in operating block 109, and according to a constant L1, relative to the “weight” that the signal C must have in LO, and the signal C itself.

As indicated, the operator 11 makes the results available for the respective uses.

Considering FIG. 4c, the flow chart illustrated relates to the implementation of the TUP1, TDOWN1 commands for mast 9 swinging according to the TUP, TDOWN commands, respectively relative to mast 9 angling backwards towards the truck and forward, set by the truck 2 driver OP.

In operating block 113 the signal C is assessed and, if it is greater than 85%, mast 9 forward swinging is stopped (TDOWN=0, block 114).

In operating block 115 the TUP1 and TDOWN1 command signals are then calculated, that is to say, the TUP and TDOWN commands are modulated, substantially in steps, according to respective time constants RC3 and RC4, to make their execution less sudden.

In operating block 116 a limit value TO is calculated for the swinging speed, both forward and backward, according to the new TUP1, TDOWN1 commands, to C and to a constant L2 indicating the incidence of the signal C required in the calculation of TO.

With reference to FIG. 4d, the flow chart relative to limitation of the truck 2 speed V should be noticed.

In operating block 119 the slide 10 height ‘hL’ is compared with a reference value, for example 100 cm, and if the slide height exceeds the reference height the truck speed 2 cannot exceed a speed limit value L4 (operating block 120).

If the signal C is greater than 95% (operating block 121), the truck 2 speed V is limited to a value equivalent to half the limit L4 in operating block 122.

In operating block 123 a command VO is then calculated to adjust the speed v according to command VI set by the driver OP, and according to the actual truck 2 speed V and the signal C.

In parallel with the manoeuvres described deriving from the implementation of instructions for the truck 2 intended to reduce all static and dynamic phenomena which may jeopardise stability, the processor 27 also implements a strategy for indicating the truck 2 equilibrium condition.

With reference to FIG. 4e, notice, downstream of an operating block 125 for zeroing the LED scale, a set of operating blocks (from 126 to 134) where the signal C is compared in succession with greater percentage limit values.

Each comparison produces (operating blocks 135 to 143) a different indication gradually as the truck 2 equilibrium becomes more precarious.

In the case of the indicator device 29 described by way of example, the first four LEDs are green, the firth and sixth are yellow, whilst the seventh is red.

The branches of the single flow chart illustrated in FIGS. 4b to 4e all terminate with a respective end of calculation operating block numbered from 400b to 400e.

It should be noticed that the check strategy, described by way of example and without in any way limiting the scope of the inventive concept, is continuously and cyclically implemented during truck 2 operation, that is to say, after the respective end blocks, implementation restarts substantially from block 201 illustrated in FIG. 3.

The control and check functions originating from the computerised unit 22 are not described in detail since they are not part of the present invention.

The methods for carrying out commands and/or correcting commands set by the driver OP may be substantially known.

For example, with reference to details not illustrated, since the lifting apparatus 8 is normally hydraulic, corrections to the swinging or upstroke speed may be made by increasing or reducing the delivery of oil in the pipes, by adjusting the speed of rotation of the pumps, which are normally electric.

Similarly, adjustments may be made to the flow rate of oil in electroproportional valves.

The invention brings important advantages.

Firstly, the truck 2 has an automatic device 1 which stops the lifting apparatus 8 every time the operator is lifting an excessive load X or is lifting a load to a height which jeopardises truck 2 stability. Advantageously, the operator does not need to assess the weight, nor the height of the load X, since the device 1 independently checks the weight and the height.

Moreover, the signal C obtained based on the instantaneous deformations of the rear axle 5 represents the equilibrium of the entire truck 2 about the front axle 4.

Geometrically, considering the truck 2 longitudinal equilibrium, it should be noticed that the overall weight is substantially distributed on the two axles 4 and 5, therefore, the rear axle 5 gradually becoming lighter, with its consequent deformations, indicates a tendency to tip forward.

It should be noticed that an approach of this type produces a real image of truck 2 stability and becomes an aid for the truck 2 driver.

Moreover, the device 1, with a simple structure and user-friendly, is easily adapted for any fork lift truck of the type with four wheels and even for fork lift trucks with three wheels or with twin rear wheels, in which the load on the rear axle can be measured.

The commands implemented, substantially according to the truck 2 equilibrium, modulate the commands provided by the driver, making the truck 2 more stable, reducing the risks for the driver and assisting him with manoeuvres.

The invention described may be subject to modifications and variations without thereby departing from the scope of the inventive concept as described in the claims herein.

1. A safety device for a fork lift truck (2), the fork lift truck (2) comprising a chassis (3), a front axle (4) and a rear axle (5) fitted with respective wheels (6, 7) and supporting the chassis (3), a lifting apparatus (8) attached to the chassis (3) at the front axle (4), comprising means (31) for acquiring information relative to the load (X) lifted by the apparatus (8), a processing unit (18) connected to the acquisition means (31), and safety means (30) which act on the truck (2) following a signal (S, S1, S2) processed by the processing unit (18); the safety device being characterised in that the acquisition means (31) comprise a detector (50) attached to the lifting apparatus (8).

2. The device according to claim 1, characterised in that the detector comprises: a weight sensor (51) for measuring a weight value (P) for the load (X) lifted, and a height sensor (52) for measuring a distance value (D) from the base (54a) of the chassis (3) to the load (X).

3. The device according to claim 2, characterised in that the weight sensor (51) is attached to a lifting apparatus (8) slide (10) set up to lift the load (X).

4. The device according to claim 2, characterised in that the weight sensor (51) is attached to a lifting apparatus (8) piston (11), the piston (11) acting on a slide (10) for lifting the load (X).

5. The device according to claim 3, characterised in that the height sensor (52) comprises a transmitter element (53) attached to the slide (10) for sending an ultrasound signal (U) and a receiver element (54) attached to a base portion (54a) of the chassis (3) for picking up said ultrasound signal (U).

6. The device according to claim 5, characterised in that the height sensor (52) also comprises a block (55) for processing the ultrasound signal picked up by the receiver element (54); said processing block (55) supplying the value representing the distance (D) according to the speed of the ultrasound signal (U) and the time the signal (U) takes to be picked up by the receiver element (54).

7. The device according to claim 2, also comprising an analogue-digital converter (56) for converting the weight value (P) and the distance value (D) supplied by the sensors (51, 52) from analogue to digital values.

8. The device according to claim 7, characterised in that the processing unit (18) is connected to the converter (56) to receive the digital values and compare them with preset weight and height parameters; said signal (S, S1, S2) processed by the unit (18) indicating the truck (2) safety status according to the weight value (P) and the distance value (D).

9. The device according to claim 8, characterised in that the safety means (30) comprise an indicator device (29) attached to the truck (2).

10. The device according to claim 9, characterised in that the indicator device (29) comprises a visual warning device (29a).

11. The device according to claim 9, characterised in that the indicator device (29) comprises an acoustic alarm (29b).

12. The device according to claim 1, characterised in that the safety means (30) also comprise a control part (57) for activating or deactivating the lifting apparatus (8) according to the signal (S, S1, S2) processed by the processing unit (18).

13. The safety device according to claim 1, characterised in that the acquisition means (31) also comprise a load detector (13) attached to the rear axle (5).

14. The device according to claim 13, characterised in that the load detector (13) comprises a strain gauge transducer (17) integral with the rear axle (5), said information being determined by a bending deformation of the rear axle (5).

15. The device according to claim 14, characterised in that the transducer (17) comprises at least one Wheatstone strain gauge bridge (15) or simple strain gauge (16).

16. The device according to claim 15, characterised in that the Wheatstone bridge (15) comprises at least one semiconductor strain gauge.

17. The device according to claim 15, characterised in that the Wheatstone bridge (15) comprises at least one glued conductor strain gauge.

18. The device according to claim 15, characterised in that the Wheatstone bridge (15) comprises at least one non-glued conductor strain gauge.

19. The device according to claim 14, characterised in that the load detector (13) comprises a bar (14) securely fixed to the rear axle (5), the strain gauge transducer (17) being connected to the bar (14).

20. The device according to claim 1, characterised in that the processing unit (18) comprises an analogue conditioning device (19) for modulating the information, said information consisting of an analogue signal.

21. The device according to claim 20, characterised in that the processing unit (18) comprises an analogue—digital converter (21) for converting the analogue signal into a digital signal and a computerised check and control unit (22) which receives the digital signal as input for implementing a strategy for use of the safety means (30).

22. The device according to claim 21, characterised in that the check and control unit (22) comprises a digital conditioning device (23) for modulating the digital signal.

23. The device according to claim 21, characterised in that the truck (2) comprises a communication channel (12) supporting a plurality of instructions about truck (2) operation and also characterised in that the safety means (31) comprise a connection interface (28) located and active between the check and control unit (22) and the communication channel (12), allowing the unit (22) to acquire the instructions from the channel (12) and return them suitably reprocessed according to the digital signal.
